(19) United States
(12) Patent Application Publication
(10) Pub. No.: US 2012/0266058 A1
(43) Pub. Date: Oct. 18, 2012

(54) EmovieBook

(76) Inventor: Pearlie Kate Miller, JR., Sherman Oaks, CA (US)

(21) Appl. No.: 13/088,126

(22) Filed: Apr. 15, 2011

(51) Int. Cl. G06F 17/00

(52) U.S. Cl. 715/205

(57) ABSTRACT

An author enhances the reading experience by adding hyperlinks from the internet, inside their (e)book, script, instructional booklet, or manuscript that displays a visual/audio/text companion. Scripts with links show how scenes should look—similar to a movie or TV show pilot but shorter. Electronic Movie Book (EmovieBook) is a book with links to visual/audio/text aids. Any computer with internet access is required. The method is reading with hyperlinks to visual/audio/text aids, references or instruction.

### CROSS REFERENCE

This “EmovieBook” invention has been previously filed with the United States Patent Office with the Attorney Docket number of 8005371 receipt date Apr. 30, 2010 as a provisional patent. All fees were paid and the filer authorized is: Adam Thomas time stamped 13:01:38 via Legal Zoom with an EFS ID: 7524231 and confirmation number 1891.

### BRIEF SUMMARY

This is a method invention in which any ordinary electronic book contains hyperlinks placed in appropriate and relevant places in the electronic book that connects to the internet to take the reader to see either an image, text, video or audio file that already exists on the worldwide web for added enjoyment and/or information.

### BACKGROUND OF INVENTION

This method invention came about while writing the manuscript “Pseudocide Did Michael Jackson Fake His Death to Save His Life?” Since one of the publishing options is to make a book available electronically, and many of the references used were from Michael Jackson fans and other news agencies, I wanted the reader to be able to see the work/videos/articles/photos/audio files that already existed on the interne, so I decided to add hyperlinks throughout the manuscript, so the reader can verify and/or see/watch what I was explaining in the book. To my surprise, a book was never published like this before, so I decided to patent this method.

### SUMMARY

This EmovieBook will revolutionize the book publishing industry by incorporating hyperlinks into the text of an electronic book as a companion. These links can be to videos, audio recordings, text, i.e. any page on the worldwide web. By doing this, the reader can have the fulfillment of reading a book, and choosing to click on supportive links to either verify, see for themselves, or corroborate the particular point, theme, etc. of the ebook. This EmovieBook is simply an electronic book with hyperlinks, which has never been published before. This is proven in the “claims” portion of this application for a non-provisional patent.

### DETAIL

Since electronic books already exists but no book has been published to included hyperlinks throughout, a simple addition of hyperlinks is added so the reader has the bonus of watching and reading at the same time. Any book can be transform into a different reading experience by adding in hyperlinks. For example a large publishing house such as Random House who has thousands of titles can revamp their entire catalogue by having an author or editor add in hyperlinks so the reader can have a bonus element of enjoyment.

Since the uprising of digital devices has exploded in the past few decades this method invention (EmovieBook) fits perfectly with trend of today.

This new method of book writing revolutionizes the way books are read. It blends the natural trajectory of computer technology by integrating reading with watching. Elbow Grease Productions a “DBA” owned by Pearlie K. Miller, Jr. has patented this process and named it “EmovieBook”.

This method invention upgrades the way people read books, like electronic books. “EmovieBooks” are useful for ipad, kindle books, and such computer technologies. Inside the “EmovieBook” will be links to visual aids, such as videos, or short films (with or without sound) that help the reader with important information or imagery. Called either an “EmovieBook”, “e-video-book”, “electronic movie book”, “electronic video book”, “e-motion picture book”, “electronic motion picture book”, “e-overall entertainment book”, “e-entertainment book”, “e-interactive book”, etc.; it advances the reading experience for anyone using internet access.

Inside the “EmovieBook” are links that help move the story along with connections to helpful visual/audio aids such as short films, movies, videos, moving pictures, still shots, instructional examples, or articles that are either created by the author or by others, where many people or organizations can receive credit for their work and traffic to their website/webpage due to its listing (hyperlink) in the “EmovieBook”, etc..

Internet advertising is also another byproduct of this technology by increasing visitor page views for the website owner. Videos can also have advertising at the beginning to ensure product exposure.

The first book to be released using this new method is “Pseudocide Did Michael Jackson Fake His Death To Save His Life?”

All the reader has to do is purchase an electronic book via some type of computer device that has an internet connection, when this electronic book is received on the computer device such as an ipad, PC, kindlebook or like device with internet connection, the reader reads normally until a link or symbol or highlighted word appears that tells the reader a hyperlink is available that corroborates with the written text. The reader can click on the internet links and connect to the worldwide web and see what the author intended and when the reader is finished using the linked information, the reader simply either closes that link or minimizes it and continues to read. The reader can also chose to see other links on that particular webpage, but can always go back to the electronic book and continue to read if they chose. It is not necessary for the reader to click on every link, the reader can chose not to click on links and the book will be written so the reader can understand the author's intent without clicking on any clicks—the links are a choice to use or not use.

As you can see, a link is placed at a specific place in the “EmovieBook” that helps the reader see what is described or needed to move the story along for either better understanding, validation, collaboration, or excitement via a visual/audio aid.

An author enhances the reading experience by adding hyperlinks from the interne, inside their “EmovieBook”, script, instructional booklet, or manuscript that displays a visual/audio companion. Scripts w/links show how scenes should look--similar to a movie or TV show pilot. Electronic Movie Book (“EmovieBook”) is a book w/links to visual/audio aids. Any computer with interne access is required. The method is reading with hyperlinks to visual/audio aids, references or instruction.

Any book or story should be strong enough without utilizing links; links are additions for the purpose of verification of facts, creating mood, collaborating ideas or opinions with others, or just to have imagery.

This process works well with fiction, non-fiction, instructional, educational, corporate training, historical and even resumes.

The world of book publishing is losing revenues year over year, this new method of book reading while watching can enhance any catalogue by reissuing classic titles, especially biographies of famous people. For example, a book about Martin L. King, Jr or John F. Kennedy can be revised to add links to famous speeches, outings, happenings or occurrences so the reader has a visual perspective as well as the written words.

This method invention “EmovieBook” will make the publishing industry millions upon millions of dollars by adding in hyperlinks to any electronic book published or physical book with an attached list of suggested links for corresponding pages/paragraphs. This never before utilized method will intrigue the world wide public because reading is just not reading anymore, it is watching/listening with collaborations with an outside element that already exist on the internet. Books have never been watched before.

This method invention is innovative and matches with the public's use of electronic devices. This method invention can be sold or licensed to anyone who uses this new method. Publishers and authors will benefit greatly from this invention.

Any book can be upgraded or created to have links to improve the enjoyment of reading by adding in elements for them to watch, see, or verify.

“EmovieBook” creates an interactive environment that takes computer technology to a whole new level.

For electronic books, hyperlink distribution is a common theme throughout any “EmovieBook”, etc..

This process can work with physical books as well. This is simple because there can also be a website/webpage especially designed with page numbers that have a list of the links on a certain page. So if someone likes to have a physical book in their hands, but wants to be able to see the visuals, then they can simply go to the website or webpage designated with the links from certain pages and watch the visual aids that matches the subject/topic/theme of the section of the “EmovieBook”, etc.. Links are choices. The reader has the choice to skip certain links if so desired.

Furthermore, since links have long mixed up letters and numbers intertwined within, a computer code, like with “tiny links url”, can utilize symbols or their own computer exchanged code so the links don't look like links.

This first ever published “EmovieBook”, “Pseudocide Did Michael Jackson Fake His Death To Save His Life?” has been sold via electronic publishers since May 21, 2010 and hundreds of people have read and watched the contents without any problems. This EmovieBook was self-published to ensure the public could use this method invention without any problems. It has been problems free.

What I claimed is:

1. The EmovieBook is a method invention for the product, in which an author enhances the reading experience by strategically adding hyperlinks from the internet, inside their electronic book, electronic script, electronic instructional booklet, electronic presentation, electronic manuscript or like electronic product (known basically as an ebook) that connects to a visual/audio/text companion, such as from youtube.com, or any website that is publicly accessible, so while someone is reading from their downloaded electronic book, usually downloaded to a PC, ipad, kindle, nook or like computer device (basically made available to the public by book sellers), the reader clicks on the link(s) provided within the text and connects to watch video, see pictures, choose a virtual world, etc. that is their visual while reading—the ONLY requirements are downloaded electronic books that has the capability to connect to the world wide web or better known as the internet.
Further included in this invention, scripts with links show how scenes should look—similar to a movie, video, or TV show pilot. Electronic Movie Book (Emoviebook) is a book with links to visual/audio/text aids. Any computer device with internet access is required. The method is reading with hyperlinks to visual/audio/text aids, references or instruction. For example, if one wants to write about situation, links are included within the context of a story such as from youtube.com (video streaming site) to add more understanding with a visual/audio/text companion, which is an outside source that is or is not independent of the EmovieBook.
The device is comprised of the following:
A link will be placed at a specific place in an electronic book (ebook) that will help the reader see what is described or needed to move the story along for either better understanding, excitement, proof, or verification via a visual/audio/text aid. This will be a common procedure throughout the EmovieBook. This is simple because there can be a website/webpage especially designed with page numbers that have a list of the links of a certain page or book, which is controlled by the author. So if someone likes to have a physical book in their hands, instead of the electronic version, but wants to be able to see the visual/audio/text companion of their choosing, then they will simply go to the designated website, or webpage with the links from certain matching pages and watch the visual/audio/text aid that matches the subject/topic/theme of the section of the EmovieBook.
Following is further explanation with example for the EmovieBook, which is dependent of the main claim in the first paragraph.
This method works best when reading the book from a computer, i.e. kindlebook or ipad books, or just a regular ebook (electronic book).
Connecting to and using information from the interne will not be a copyright infringement on videos created by others because it's from the publicly accessible internet, which is available to anyone with the capacity to view it. A particular link will go directly to the creator's webpage, giving them credit and web traffic to their site or video channel, such as youtube.com or any other video streaming site. It is just like sharing is permissible on all webpages. All webpages have links to the worldwide public to use/share/view.
On the matching webpage for the EmovieBook, blogs can also be interactive.
Continuing, certain links on a page will match up to website pages and will be listed as links that match the page number or paragraph for easy follow along. There can be numbers or symbols for easy matching of the content of the EmovieBook with the corresponding hyperlink.
Videos can also be created by the author of the EmovieBook who can own the copyright if they produced/created the video specifically created to a particular EmovieBook.
A book, ebook, emoviebook, etc. and a computer (or like device) is necessary to interact together using an internet connection.
Below is an example of a hyperlink to a certain video:
http://www.youtube.com/watch?v=9BG23_Qo2fE
Also, the emoviebook, etc. could have an unlimited number of links—up to hundreds of links included in the (e)book to enhance talking movies, music videos, or any visual aid that has sound and picture or news articles so the reader can verify the originator/provider of information. Just like references are parts of any book. The reader can either click on the link and be directed to the webpage connected to that link or they can cut the link and paste it in the browser to view and be connected to the webpage that is connected to that hyperlink. And then the reader can resume reading where they left off continuing with the progression of the EmovieBook.
EXAMPLE—Here's a portion of page 135 of the first book published of this kind called “Pseudocide Did Michael Jackson Fake His Death To Save His Life?” (copyright 2010)
“By the fourth day, I was up and at it. I made a video statement and put it on our website: www.MichaelJacksonInsider.com (this is hyperlinked) and released it on several video streaming sites, like youtube: http://www.youtube.com/watch?v=9BG23_Qo2fE My promise was broken to myself because I . . . ”
All links are hyperlinks and most begin with http://, but this is not required to link to a site or page. All links will have a series of numbers, letters (or highlighted words that already exist) that can be put into a browser so to direct to a specific webpage on the internet with a video on it or article on it, etc. This alerts the reader that a companion exist and can be accessed. Like with the example above the link on page 135 is www.MichaelJacksonInsider.com and http://www.youtube.com/watch?v=9BG23_Qo2fE
Plus, in non-fiction (e)book, links can be used to verify or collaborate with what is written in the book—a reference.
Hyperlinks in the EmovieBook connect with something on the interne in the form of a video, statement, article or still shot that enhances or supports the words in the EmovieBook. Each hyperlink connects to something else that will deliver more information, confirmation of a statement, movie or video, as an aid to enhance the story or prove something in the (e)book, etc. It is supportive information/imagery usually with audio, visual or text.
Step one-purchase the (e)book from any retailer that sells electronic books.
Step two-while reading the book, there will be either a webpage with all the hyperlinks and then use the hyperlinks to link to certain elements used to interact with the point, words, directions, and imagery of the book. For example, a video has visual aids and audio for an extra reading experience, so to connect with the written words in a specific paragraph in the EmovieBook. Some videos, movies, motion pictures can have music as well as voice-over and text.
Step three-after viewing what the hyperlink links to, one can resume reading the EmovieBook at the point where they left off, or chose to ignore certain links and proceeds reading. The links are there for an added audio/visual experience or links can be for additional information.
These steps are continuous and on-going throughout the reading experience. An EmovieBook can have any number of links.
And by being an interactive (e)book, one can share information that others have created to add to or enhance a point/theme in the story or (e)book. Links can be to anything on the publicly accessible internet. The author makes no promises that these links will exist forever because some links can be owned and controlled by others, which means they can be removed at any time. The author can have a disclaimer in their EmovieBook stating such.
This method can be used by anyone who wants to interact an (e)book with audio and visual links that enhance reading with watching and listening. Also serves as point of reference to where information is disseminated. For example:
Instructional Guides/Books
(e)Learning
Educational (schools)
Corporate (training)
Novels
Historical
Non-Fiction books
Fiction
Resumes can have hyperlinks to a video statement to a potential employer
Any form of writing/text can have links or highlighted words included in them to create an interactive environment where words and movie pictures interact in a different way than just with books with an attached CD/DVD.
This EmovieBook, etc. simply connects with certain specified portions of the internet by way of using a computer and hyperlinks.
For example, if the EmovieBook talks about Franklin Delanor Roosevelt's speech, there could be a link to watch that historic speech or if a portion of the book mentions the attack on Pearl Harbor, a link can correspond to footage of the attack. That link could be from any publicly accessible website/webpage that has that footage and/or the word “Pearl Harbor” can be highlighted to signal to the reader a link is available.
If someone wanted to make a comparison, there could be links to what needs to be compared. If quoting someone in an interview, a link can be inserted so the actual interview can be viewed.
“Pseudocide Did Michael Jackson Fake His Death To Save His Life?” is the first fully interactive (e)book to be published and put on the market as an EmovieBook where links are inserted to designated webpages as a companion to add excitement, more information, or proof of what is written. Specifically for the (e)book an interactive CD-Rom or DVD can be included with the paperback or hardcover editions of the EmovieBook.
The problem is people are reading less books and this invention, EmovieBook, etc., will combine reading with watching and listening. This method will combine the pastime of reading with the pastime of watching movies, films, videos, etc.. It will be a book that is completely interactive with movies, pictures, still shots, or published articles as references that support certain portions of the book. All that is needed are hyperlinks to view the companion audio/visual/text aids.
This will enhance novels, non-fiction, and instructional books to be more exciting by offering choices of characters in a story, architectural designs of houses or offices, type of atmosphere/climate/forestry/urban development, etc. that fits the reader's imagination. This could be produced specifically for the EmovieBook or something already existing on the internet. On a webpage designed to match the EmovieBook, there will be choices of characters and locations, etc. that the reader can use in their imaginations while reading the book. It can connect to a virtual world for example.
Even though instructional guides already exist in some type of interactive form, this is just an additional method. Instructional books can have audio/visual examples of what they are teaching. For example, dissecting a frog in biology class can link to a video of someone actually dissecting the frog the right way or the wrong way. A question could be which way is the right way? Multiple choices can be in the form of a video. Guitar lessons in a book can have hyperlinks as companions to show how to play or hold a guitar correctly. The EmovieBook can stand alone, but for a book to have hyperlinks to visual aids just enhances the learning experience. Like a teacher does but this can be done at home, office or in the classroom.
Also, EmovieBook, etc. would be a great relationship book where there are links (produced by the author or already in existence on the internet) about how to behave on a date or how to handle a particular situation on a date.
For example, if someone was traveling and only had their cell phone (or laptop, ipad, or kindlebook) that has internet access, they can read the EmovieBook version, etc. and link to the specified webpages/websites indicated in the (e)book, CD-Rom, or physical book (paperback or hardcover) by copying the links and putting it in their browser to watch or listen to the visual/audio aid. It will be completely interaction, which represents reading plus watching then choosing.
The first book to use this new method of book writing is for the book called “Pseudocide: Did Michael Jackson Fake His Death To Save His Life?”
